(19) United States
(12) Patent Application Publication
(10) Pub. No.: US 2006/0133114 A1
(43) Pub. Date: Jun. 22, 2006

(54) Dynamic wall light with visual effect of running water from faucet

(76) Inventor: Hung-Huai Shen, Taipei Hsien (TW)

Correspondence Address: DAVID E. DOUGHERTY;Dennison, Schultz, Dougherty & MacDonald, Suite 105, 1727 King Street, Alexandria, VA, 22314-2700, US

(21) Appl. No.: 11/014,878

(22) Filed: Dec. 20, 2004

(51) Int. Cl. H01R 33/00

(52) U.S. Cl. 362/659

(57) ABSTRACT

A wall light includes a faucet-shaped body on the upper part, a transparent cylindrical container in the middle part and a base on the lower part. The transparent cylindrical container is vertically installed between the lower outlet of the faucet-shaped body and the base with low-boiling-point clear liquid and lustrous foil fragments therein. The base having a cup and a plug for installing on wall surface and mounting the light bulb providing lighting from the bottom side of the transparent cylindrical container. In usage, the bulb heats the low-boiling-point clear liquid to make the lustrous foil fragments with differently colors flowing upwards or downwards by convection currents. Thus the transparent cylindrical container has colorful and glittering dynamic effect, together with the faucet-shaped body on the upper part, the wall light creates visual effect of running water from the faucet-shaped body and achieves better decorative effect.

### BACKGROUND OF THE INVENTION

The present invention relates to a wall light, especially to a dynamic wall light with visual effect of running water from faucet that consists of a faucet-shaped body on the upper part, a transparent cylindrical container in the middle part and a base on the lower part. By a plug on the base, the wall light is installed on a socket on the wall. Through a light bulb on the base, low-boiling-point clear liquid is heated and generates convection currents so as to drive a plurality of lustrous foil fragments with differently colors flowing. Thus turn the transparent container into a colorful and glittering ornament with dynamic effects. In combination with the faucet-shaped body on the upper part, the wall light has visual effect of running water from the faucet so as to have both lighting and decorative effects.

Traditional wall lights for lighting or decoration are with various structure or designs. However, such kind of lights is static without special visual effects. A conventional lamp showing floating and lustrous foil fragments, as shown in FIG. 1 of U.S. Pat. No. 6,309,084B1—“LAMP SHOWING DYNAMICALLY CHANGEFUL LUSTER AND SHADOW”, consists of a transparent container with low-boiling-point liquid and a plurality of lustrous foil fragments with differently colors inside. By a light bulb with power source for lighting and heating, the low-boiling-point liquid is heated and the lustrous foil fragments are driven by convection currents, flowing upwards or downwards. Thus the wall light has dynamic visual effect. But the visual effect only focuses on the transparent container, other components such as the base and an upper cover don't have any decorative effect, only with practical functions. Thus there is a need to provide a wall light, or a lamp with lustrous foil fragments with better and integrated decorative effect.

### SUMMARY OF THE INVENTION

It is a primary object of the present invention to provide a wall light with visual effect of running water from faucet that includes a faucet-shaped body on the upper part, a transparent cylindrical container in the middle part and a base on the lower part. The transparent cylindrical container is arranged between the lower outlet of the faucet-shaped body and the base for displaying visual effects. Low-boiling-point clear liquid and a plurality of lustrous foil fragments with differently colors are filled inside the transparent cylindrical container. The base having a plug for installing on a socket of the wall and a bulb for lighting. When being used, the wall light is connected with the socket on the wall by the plug of the base while the faucet-shaped body on the upper part attaches the surface of the wall so as to make the device look like a real faucet. The bulb in the base illuminates the transparent cylindrical container and heat the low-boiling-point clear liquid to make the lustrous foil fragments with differently colors flowing upwards or downwards. Therefore the transparent cylindrical container has colorful and glittering dynamic effect, together with the faucet-shaped body on the upper part, creating visual effect of running water from the faucet-shaped body so as to achieve better decorative effect.

### BRIEF DESCRIPTION OF THE DRAWINGS

FIG. 1 is a perspective view of the present invention;

FIG. 2 is an explosive view of the present invention;

FIG. 3 is an embodiment of the present invention when being used;

FIG. 4 is a cross-sectional view of the present invention;

FIG. 5 is a perspective view of another embodiment of the present invention;

FIG. 6 is a perspective view of a further embodiment of the present invention;

FIG. 7 is a perspective view of a further embodiment of the present invention.

### DETAILED DESCRIPTION OF THE PREFFERED EMBODIMENT

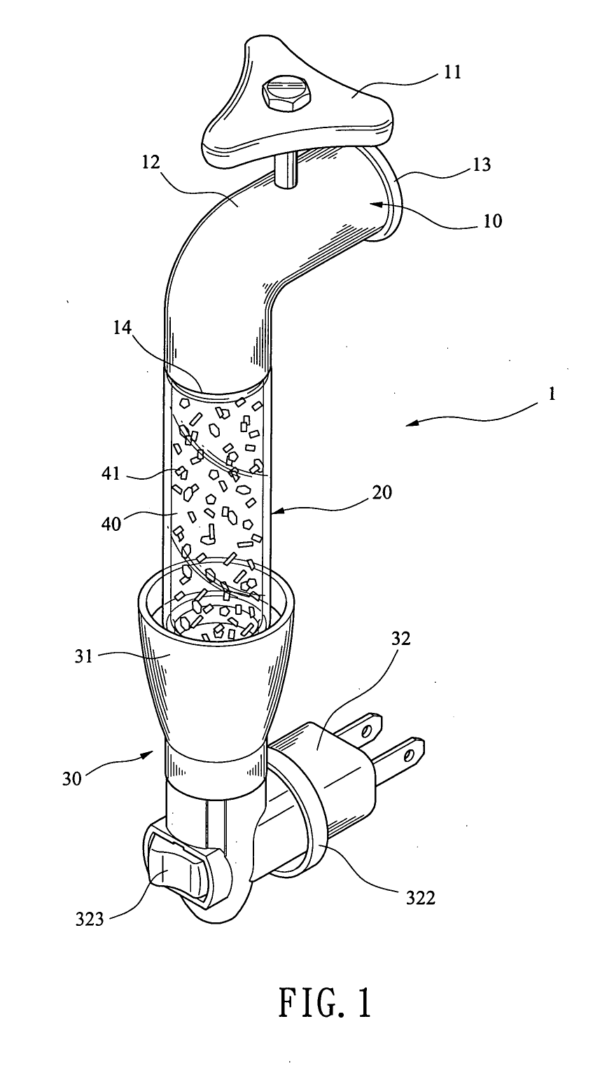

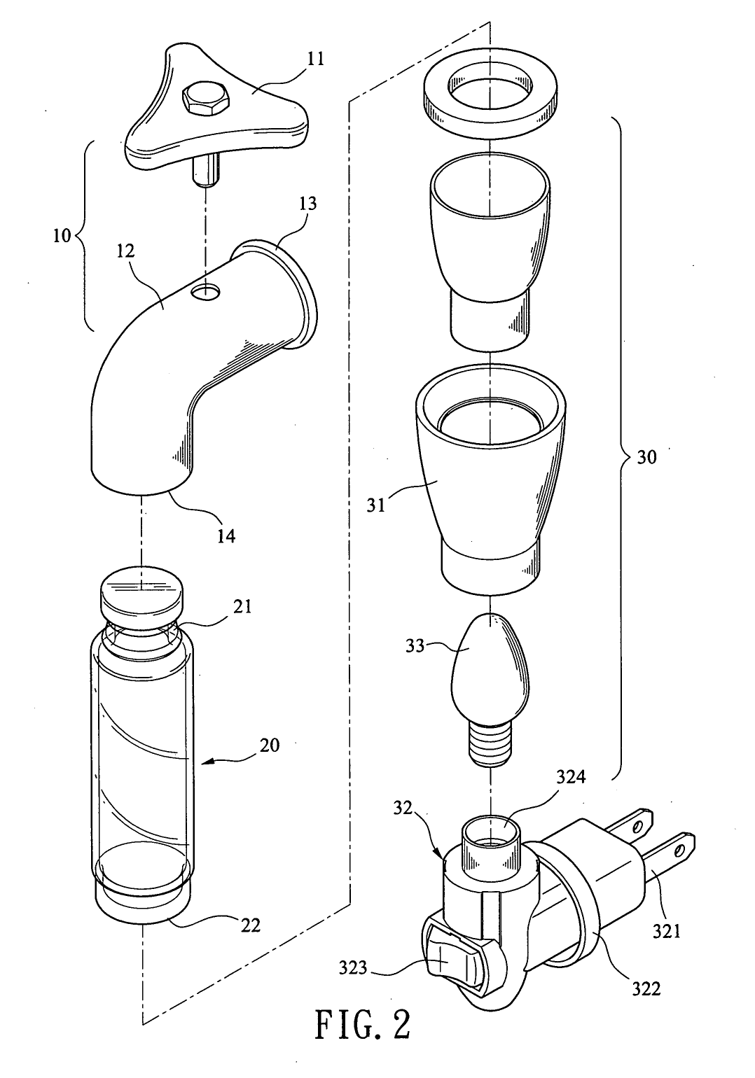

Refer to FIG. 1 & FIG. 2, a dynamic wall light 1 in accordance with the present invention includes a faucet-shaped body 10 on the upper part, a transparent cylindrical container 20 in the middle part and a base 30 on the lower part. The faucet-shaped body 10 is a component with faucet-like appearance, having a controller 11 and a L-shaped tube 12 that are made by plastic injection molding and then being assembled. The L-shaped tube 12 is composed of an upper outlet 13 and a lower outlet 14. The lower outlet 14 is like a spout of the faucet and is installed on top 21 of the transparent cylindrical container 20 that is a closed transparent container with certain length and is made of glass or thermoresistant plastic. The transparent cylindrical container 20 is vertically installed between the lower outlet 14 of the faucet-shaped body 10 and the base 30 on the lower part so as to produce effect of running water. Low-boiling-point clear liquid 40 and a plurality of lustrous foil fragments with differently colors 41 are filled inside the transparent cylindrical container 20. The base 30 is composed of a cup 31 and a plug 32. The cup 31 is covered on top of the plug 32 for receiving the bottom side 22 of the transparent cylindrical container 20 and enclosing a light bulb 33 therein. While the plug 32 is a general one or a rotatable plug as shown in FIG. 1 & FIG. 2. The plug 32 consists of two pins 321, a rotating mechanism 322, a switch 323, and a bulb base 324. The pins 321 are connected with the socket on the wall while the rotating mechanism 322 is used to adjust the direction of the plug 32 for matching the socket in vertical or horizontal direction and keeping the bulb base 324 and the cup 31 in vertical direction. The switch 323 controls on and off of the light bulb 33. Moreover, the light bulb 33 emits light towards the bottom side 22 of the transparent cylindrical container 20 for lighting.

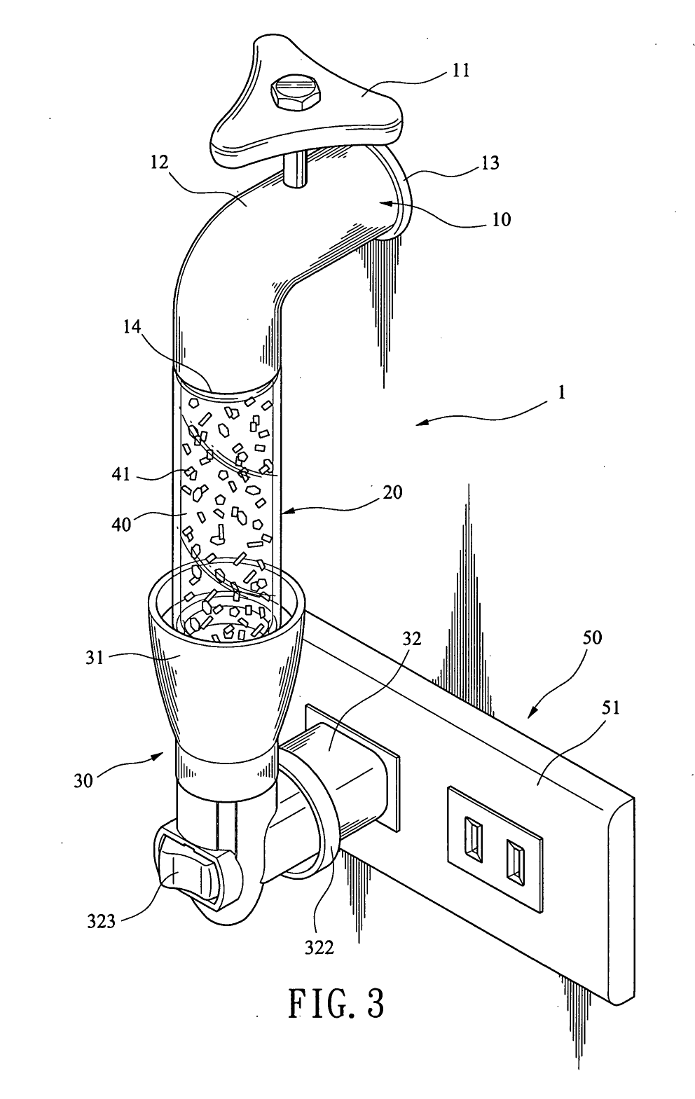

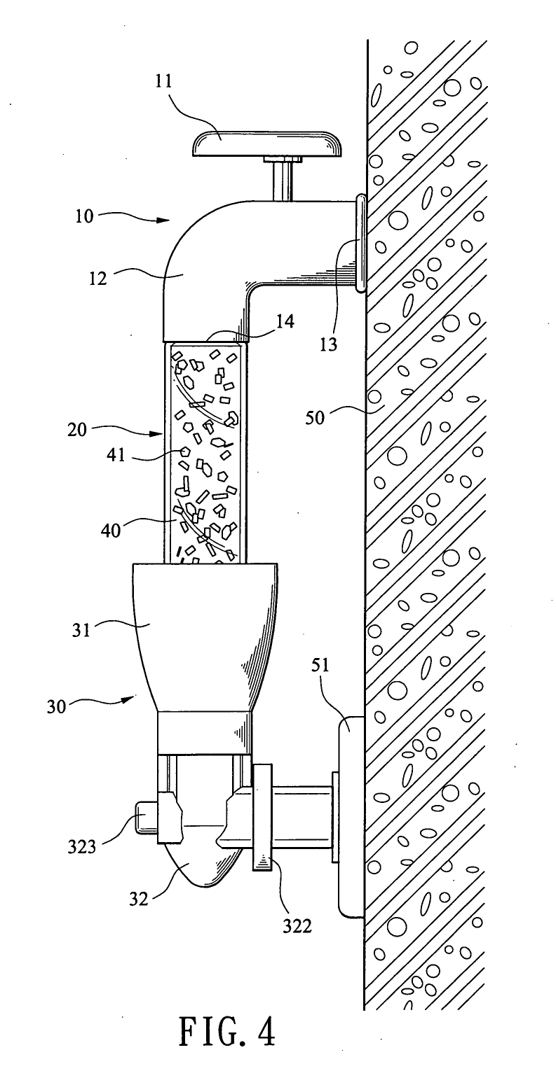

Refer to FIG. 3 & FIG. 4, the two pins 321 of the plug 32 inserts on the socket 51 of the surface of the wall 50 and the cup 31, the faucet-shaped body 10 as well as the transparent cylindrical container 20 keep in vertical direction along the surface of the wall 50. The upper outlet 13 on the L-shaped tube 12 of the faucet-shaped body 10 is just attached on the surface of the wall 50 closely so as to make the wall light look just like a faucet on the surface of the wall 50 when being used. Then open the switch 323 to lighten the bulb 33 inside the cup 31 and the light beam passes through the bottom side 22 of the transparent cylindrical container 20. The bulb 33 also heats the low-boiling-point clear liquid to generate convection currents for driving lustrous foil fragments with differently colors 41 flowing upwards or downwards. Through the lighting from the bulb 33 and the reflection of lustrous foil fragments with differently colors 41, the transparent cylindrical container 20 forms a colorful, glittering column with flowing effect, in combination with the faucet-shaped body 10 on upper side as well as the cup 31 on the lower side, the present invention has novel decorative effect.

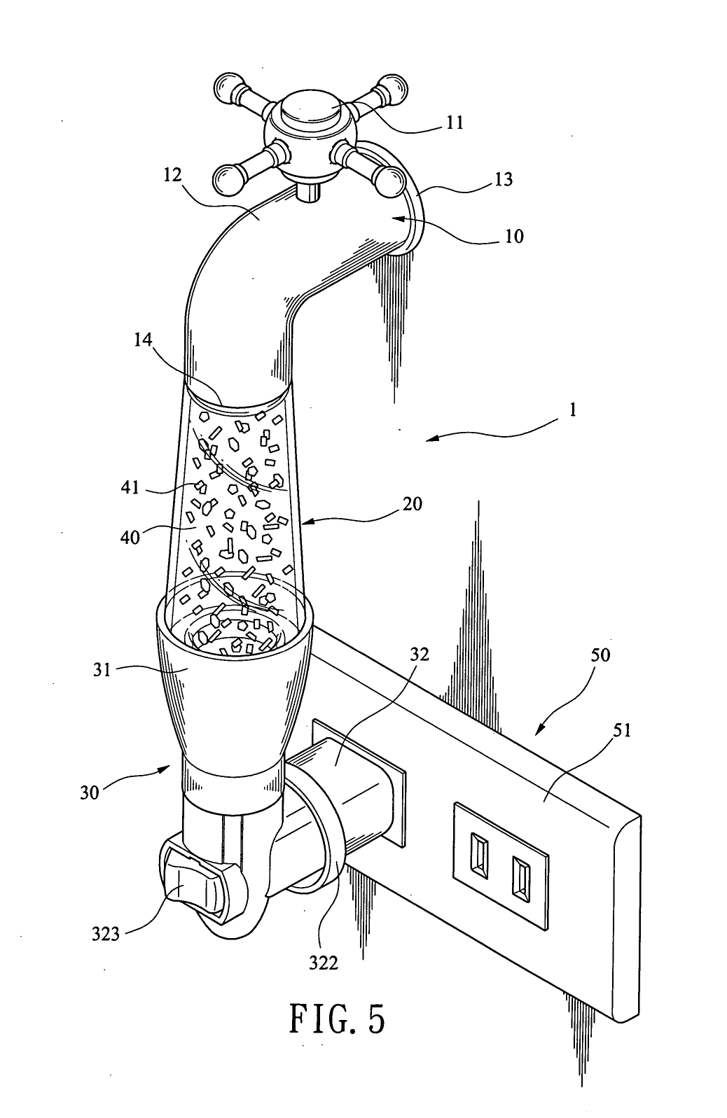

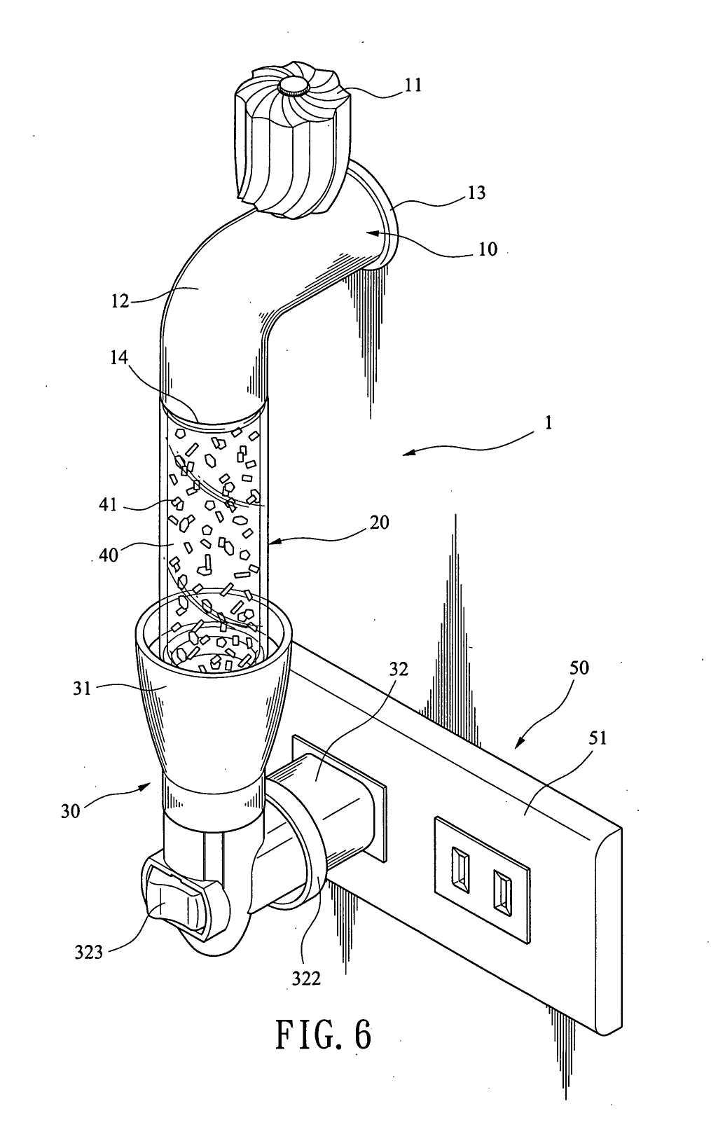

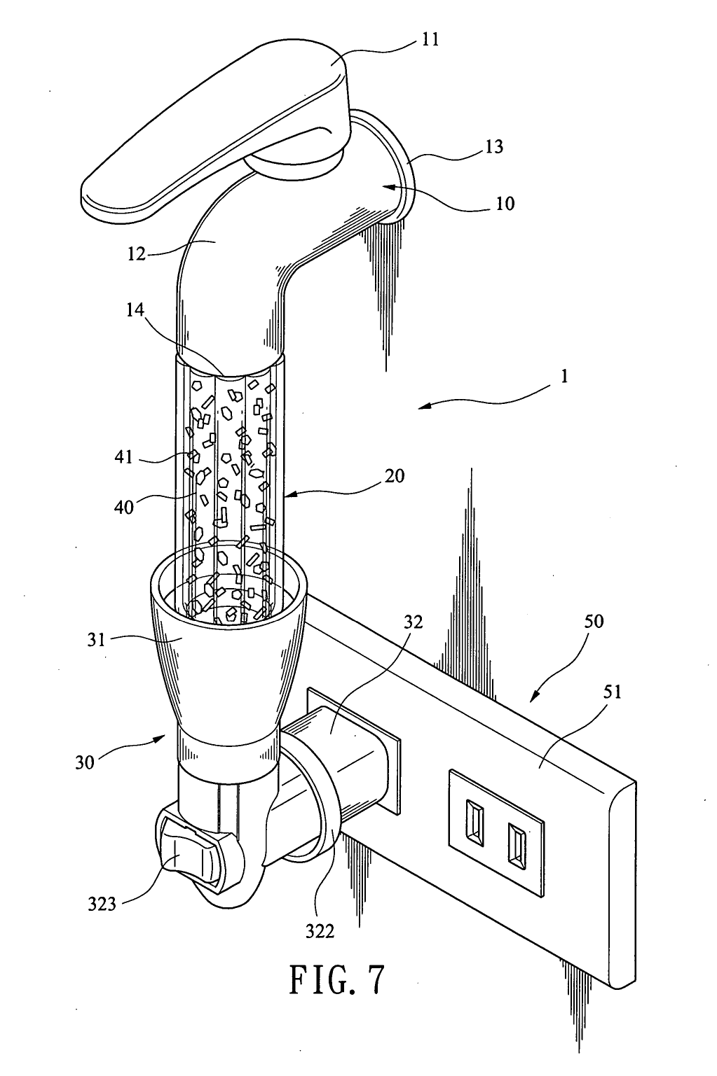

Refer to FIG. 1, FIG. 5, FIG. 6, & FIG. 7, the faucet-shaped body 10 and the cup 31 of the present invention are designed with various styles. The controller 11 of the faucet-shaped body 10 can be a triangle, as shown in FIG. 1, a quarry, as shown in FIG. 5, a column with at least a slope, as shown in FIG. 6, or a handle, as shown in FIG. 7. While the transparent cylindrical container 20 can be a linear tube as shown in FIG. 1, or a conical form, as shown in FIG. 5, or a linear tube with wavy surface, as shown in FIG. 7.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A wall light with visual effect of running water from faucet comprising a faucet-shaped body on the upper part, a transparent cylindrical container in the middle part and a base on the lower part, wherein:
the faucet-shaped body includes a controller and a L-shaped tube with an upper outlet as well as a lower outlet; the lower outlet is installed on top of the transparent cylindrical container;
the transparent cylindrical container is a closed transparent container with certain length and is made of glass or thermoresistant plastic; the transparent cylindrical container is vertically installed between the lower outlet of the faucet-shaped body on the upper part and the base on the lower part with low-boiling-point clear liquid and a plurality of lustrous foil fragments with differently colors filled therein; the base having a cup and a plug while the cup is covered on top of the plug for receiving the bottom side of the transparent cylindrical container and enclosing a light bulb therein;
the plug having at least two pins and a bulb base facing upwards for mounting the light bulb providing lighting from the bottom side of the transparent cylindrical container;
in accordance with the above structure, the wall, light is connected with the socket on the wall by the pins of the plug and the base, the transparent cylindrical container as well as the faucet-shaped body keep vertical along the wall surface; the bulb illuminates from the bottom side of the transparent cylindrical container and heats the low-boiling-point clear liquid to make the lustrous foil fragments with differently colors flowing upwards or downwards by convection currents; by lighting of the bulb and the reflection of the lustrous foil fragments, the transparent cylindrical container has colorful and glittering dynamic effect, together with the faucet-shaped body on the upper part, creating visual effect of running water from the faucet-shaped body so as to achieve better decorative effect.

2. The wall light with visual effect of running water from faucet as claimed in claim one, wherein the controller and the L-shaped tube 12 are made by plastic injection molding in advance and then being assembled.

3. The wall light with visual effect of running water from faucet as claimed in claim one, wherein the plug is a general plug or a rotatable plug.

4. The wall light with visual effect of running water from faucet as claimed in claim one, wherein a switch is disposed on the plug.

5. The wall light with visual effect of running water from faucet as claimed in claim one, wherein the pins of the plug insert into the socket on the wall surface, the upper outlet of the L-shaped tube attaches on the wall surface closely.

6. The wall light with visual effect of running water from faucet as claimed in claim one, wherein the controller of the faucet-shaped body is a triangle, a quarry, a column with at least a slope, or a handle.

7. The wall light with visual effect of running water from faucet as claimed in claim one, wherein the transparent cylindrical container is a linear tube, a conical form or a linear tube with wavy surface.
